(19) United States
(12) Patent Application Publication
(10) Pub. No.: US 2009/0089321 A1
(43) Pub. Date: Apr. 2, 2009

(54) Method and system for managing social brokering services in an online social network

(75) Inventors: Yu-Sok Yang, Seoul (KR); Jae-Hong Kim, Seoul (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: O WAVE MEDIA CO., LTD.

(21) Appl. No.: 12/285,029

(22) Filed: Sep. 29, 2008

(30) Foreign Application Priority Data
Oct. 1, 2007 (KR) 10-2007-0098615

(51) Int. Cl. G06F 17/00

(52) U.S. Cl. 707/102; 707/100; 707/E17.001

(57) ABSTRACT

A method and system for managing social brokering services in an online social network has developed that is comprising: social network database storing member information, human network information by member information on basis of a social network, and Needs information; an application server converting written Needs request into Needs information and storing it as said social network database after making payment of charges for use when the written Needs request for solving problems is inputted from Social Brokering Users, acting as members, providing Needs proposal with Social Brokering Users when the written Needs proposal is conveyed from Social Brokers, members, making payment of the amount according to types of dealing, like purchase, sales, exchange, etc., and contracts upon establishing contracts between Social Brokering Users and Social Brokers, and transferring the payment amount upon completing the contract; a Needs server delivering undelivered Needs information to the first human connection according to human network information of Social Brokering Users or Social Forwarders by searching Needs information stored in said social network database; and a payment server processing charges for use and payment when payment is executed in said application server. According to the present invention, it is possible to describe the problem and set up the amount of compensation in case that it is required to resolve various visible and invisible problems each member obtains; to overcome problems of trust and reliance by utilizing connection among people as brokers for assisting settlement of problems in the process of being delivered in accordance with a human network in the online social network if the step of delivering human connection among people is set up, and the amount of compensation(costs for dealing, and brokerage) and charges for use are paid; to support prompt settlement of problems for active anticipation of people, who have an ability to solve problems, from others; to provide costs for solving problems and brokerage in accordance with market forces for people who solve problems and to make the economical compensation granted by distributing brokerage with Needs forwarders in the middle step of human connection; and to form mutual relation during resolving problems.

### BACKGROUND OF THE INVENTION

1. Field of the Invention

The present invention relates to method and system for managing social brokering services in an online social network, more specifically, enabling to use reliable human network on a social network in order to promptly solve various problems, such as visible and invisible property trade and exchange each member wishes, smooth promotion of business, supply for human power, settlement of individual problems, acquisition of various information, etc.; perform compensation for people who solve problems as awards for solving problems; divide and distribute brokerage even for intermediate human network, acting as messengers of Needs; and form mutual human connection in the step of solving problems while members, who join online social networking services, broaden their human relationship and are interchanged with different human connection through different kinds of human network management services.

2. Description of the Prior Art

While improving the Internet, visible and invisible properties have been traded via open markets, or curiosities have been resolved by websites related to dealing with knowledge such as www.naver.com in order to partially overcome various kinds of questions that each person generally has.

E-Market Places like eBay in US, and Auction in Korea have been also called as Open Market. In the online market established by managers of e-Market Places, anyone can organize their own market, pay dealing commission, and sell their products to others after receiving authorization, and since in case for customers, there are various types of products and costs of products can be easily compared, they can extremely conveniently purchase products.

However, since business in the e-Market Places has been done toward many people, the business is led to settle a contract among good sellers or buyers by variously recording and disclosing credit status of business activities of sellers and buyers according to frequency of fraud cases, and there is a problem with maintaining human power by significant expanses.

Meanwhile, innumerable knowledge has been distributed by collective intelligence with the improved Internet. The most representative examples are www.wikipedia.com, and Knowledge iN service of www.naver.com. The former is a dictionary in which users participate, and the latter is a structure that when a user raises a question, another user answers the question and then if the proper answer is chosen, it would be delivered to large number of people via search as knowledge.

However, such services are also provided to people. Therefore, there is a problem concerning trust and reliance due to that many professionals assess knowledge by collective intelligence with mentioning that “If the knowledge is not verified, it is not knowledge.”

Further, as for www.innocentive.com, the method for paying compensation has been introduced to assist for solving issues in case that to resolve various issues like research development, companies post a question in a manner of depositing compensation to innocentive, and provide compensation if registered scientists worldwide attempt to solve the issue and succeed in solving the issue. However, any technology or system for promptly solving individual problems, not company problems, with support from reliable people is not currently provided.

### SUMMARY OF THE INVENTION

However, it is hardly know or, difficult to recognize with which field and level relationship among people is configured due to that setting up open profiles and closed profiles, and off-line and on-line relationship are widely mixed.

Therefore, it is the reality that problems are delayed to be resolved in the process of confirming the above in on-line and off-line, or introduction is recommended in spite of being familiar, or it takes too much time to deliver information. Further, services or technologies for this are not offered. Accordingly, there is a problem that problems are not immediately solved by reliable people.

Meanwhile, although people form their own human network along with making social relation with people in various fields, most of them form most of their human networks in areas, like their schools, companies, and hobbies, oneself takes much time in order to solve problems promptly through faithful human network if he or she feels a lack of ability while making an effort to solve different kinds of problems (for example, visible and invisible property trade and exchange, settlement of individual concerns, smooth promotion of business, supply for human power, acquisition of various information, etc.); people largely consult or counsel their limited human network surrounding them; and these matters have been mostly resolved by support from people, who are working in different jobs, or obtain different experiences and abilities, surrounding them.

Although it is primarily essential to require assistance from others who obtain diverse specialties and experiences for solving such matters, occasionally, it is more helpful to solve problems by human network connected to another human network rather than by direct human network in the identical area with similar experience.

In addition, in case that advices of dependable human network surrounding us are required for resolving issues, it takes much time to deliver our intention, and in case that assistance from faithful human network surrounding us rather than help from other human network is required, it takes much more time, and it takes lots of time in recognizing which field of human network their human connection acquires.

Meanwhile, there are different sorts of social networking services, such as www.myspace.com, www.facebook.com, and www.linkedin.com in US, and www.cyworld.com in Korea. However, simple-structured services, like profiles, blogs, expansion of on-line relation by making friends, or supply of news on friends or activity information, and so on, are available through most of those services.

The present invention is directed to solving above problems, and the object of the invention is to provide the method and system for managing social brokering services in an online network, enabling to describe a problem and set up the amount of compensation in case that it is required to resolve various visible and invisible problems each member obtains; to overcome problems of trust and reliance by utilizing connection among people as brokers for assisting settlement of problems in the process of being delivered in accordance with relation in the online social network if the step of delivering connection among people in the online social network is set up, and the amount of compensation(costs for dealing, and brokerage) and charges for use are paid; to support prompt settlement of problems for active anticipation of people, who have an ability to solve problems, from others; to provide costs for solving problems and brokerage in accordance with market forces for people who solve problems and to make economical compensation granted by providing brokerage for Needs forwarders in the intermediate step of human network; and to form mutual relation during resolving problems.

According to the method and system for managing social brokering services in an online network, constituted as above, in case that the social brokering system is used for solving various kinds of problems, such as visible and invisible property trade and exchange, each member wishes, on the online social network, smooth promotion of business, supply for human power, settlement of individual problems, acquisition of various information, etc., Social Brokering Users can anticipate promptly solving Needs by reliable relation; since Social Forwarders can receive brokerage if problems are solved by their before and after human connection after delivering Needs of Social Brokering Users, the Needs can be delivered by the reason for intension to help people and economical compensation in spite of inability of solving problems and thus it brings into effects in making the Needs of Users disposed towards broad relation; and Social Brokers can anticipate new relation in economical compensation and the process of solving problems with acquiring compensation from solving the Needs, and brokerage and therefore, it has an effect on promoting participation of each member for solving the Needs of Social Brokering Users on the whole of the online social network.

### BRIEF DESCRIPTION OF THE DRAWINGS

FIG. 1 is an outline diagram of the system schematically representing the constitution of the system for managing social brokering services in an online network according to the present invention.

FIG. 2 is a drawing representing an embodiment of Needs requests provided for Social Brokering Users in an application server of the system for managing social brokering services in an online network according to the present invention.

FIG. 3 is a drawing representing an embodiment of Needs information provided for Social Forwarders or Social Brokers in the application server of the system for managing social brokering services in an online network according to the present invention.

FIG. 4 is a drawing representing an embodiment of a brokering social network map provided for Social Brokering Users in the application server of the system for managing social brokering services in an online network according to the present invention.

FIG. 5 is an action flow diagram for explaining the method for managing social brokering services in an online network according to the present invention.

FIG. 6 is an action flow diagram representing steps of generating and delivering Needs information in the method for managing social brokering services in an online network according to the present invention.

FIG. 7 is an action flow diagram representing the step of circulating Needs in the method for managing social brokering services in an online network according to the present invention.

FIG. 8 is an action flow diagram representing the step of suggesting Needs in the method for managing social brokering services in an online network according to the present invention.

FIG. 9 is an action flow diagram representing steps of saving, contracting, and distributing bills to be paid in the method for managing social brokering services in an online network according to the present invention.

### DETAILED DESCRIPTION OF THE PREFERRED EMBODIMENT

The present invention to accomplish the above objects is characterized by comprising: social network database storing member information, human network information by member information on basis of a social network, and Needs information; an application server converting written Needs request into Needs information and storing it as said social network database after making payment of charges for use when the written Needs request is inputted from Social Brokering Users, acting as members, providing Needs proposal with Social Brokering Users when the written Needs proposal is conveyed from Social Brokers, members, making payment of the amount according to dealing types and contracts upon establishing contracts between Social Brokering Users and Social Brokers, and transferring the payment amount upon completing the contract; a Needs server delivering undelivered Needs information to the first human connection according to human network information of Social Brokering Users or Social Forwarders by searching Needs information stored in said social network database; and a payment server processing charges for use and payment when payment is executed in said application server.

Furthermore, said method for managing social brokering services in an online network is characterized by consisting of: member joining step of storing human network information to the social network database and creating human network after recording personal information on the website of the application server and joining as a member; Needs information generating step of filling out desired Needs requests and generating Needs information by a member himself acting as Social Brokering Users after joining the website; payment step of executing payment of charges for use by interconnecting said application sever with the payment server when Needs information is completed to be generated; Needs requests delivering step of storing Needs information, which is written Needs request recorded by the application server, to said social network database and delivering it to the first member of human connection via Needs server when payment of charges for use is completed; Needs circulating step of delivering proposal information on written Needs proposal, recorded by the first member of relation acting as Social Broker, to the Social Brokering User from said Needs server, or delivering Needs information to the first relation of the first member of relation by the first member of relation acting as Social Forwarder; payment saving step of executing payment amount and brokerage, or brokerage according to types of dealing by interconnecting with said payment server in said application server if the proposal information, transmitted by Social Brokers, is accepted by Social Brokering Users, and transferring and saving payment amount to an Escrow account server when payment is executed; contracting step of transmitting a written contract of said application server to Social Brokering Users and Social Brokers when transfer is settled; and distributing and transferring step of distributing brokerage to Social Brokers and Social Forwarders in accordance with distributed rates of brokerage by using payment amount, saved in said Escrow account server, when message for completion of contract execution is transmitted from Social Brokers and compensation is requested to be transferred by Social Brokering Users, and transferring payment amount in accordance with types of dealing to Social Brokers or Social Brokering Users.

Hereinafter, an explanation of a structure of the system for managing social brokering services in an online network according to the present invention will be given with reference to the attached drawings.

A detailed explanation on the known functions and configurations related to this invention will be avoided for the brevity of the description. And, the terms as will be mentioned below are used by the functions defined in this invention, which is of course varied in accordance with the intension or rules of a user or operator. Therefore, the definition of the terms should be based upon the contents of the description of the invention.

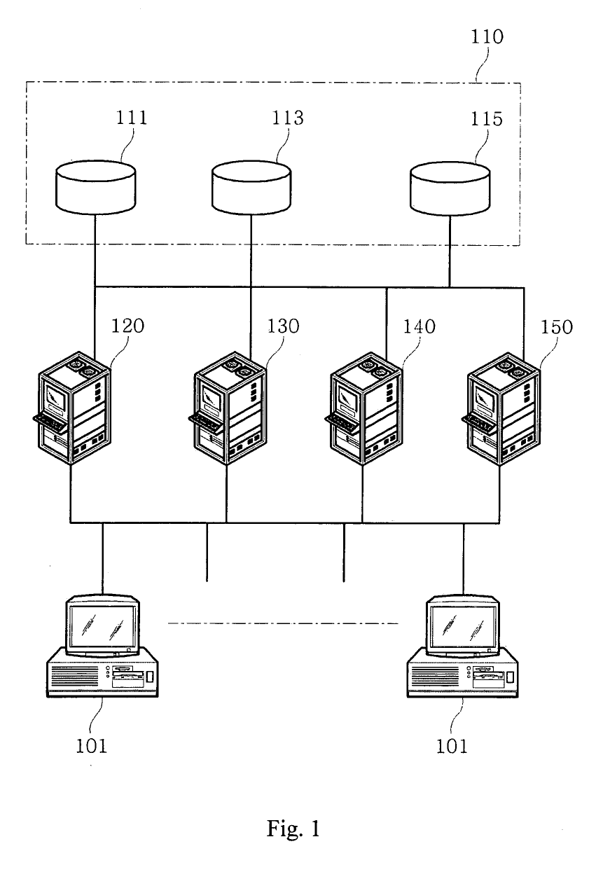

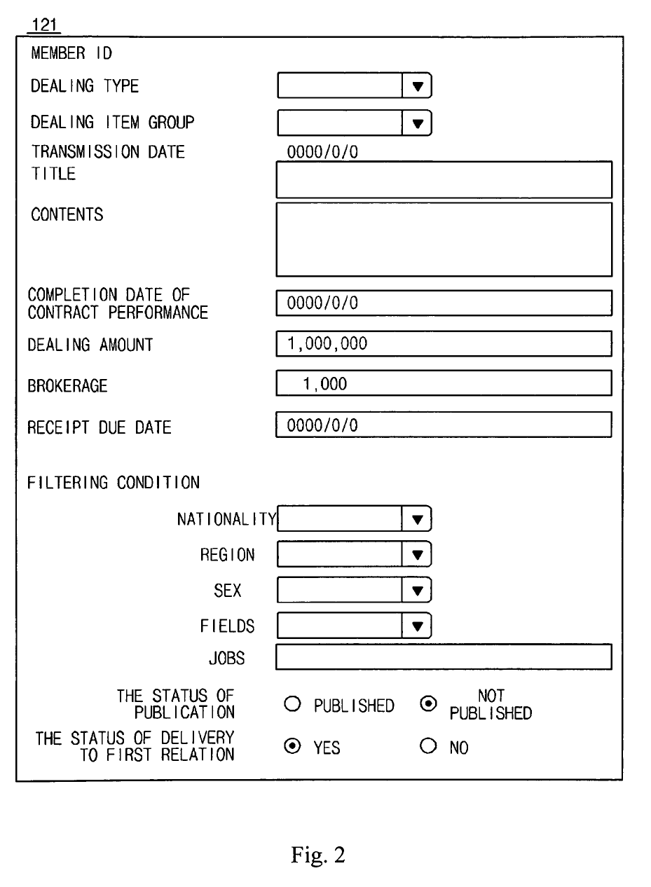

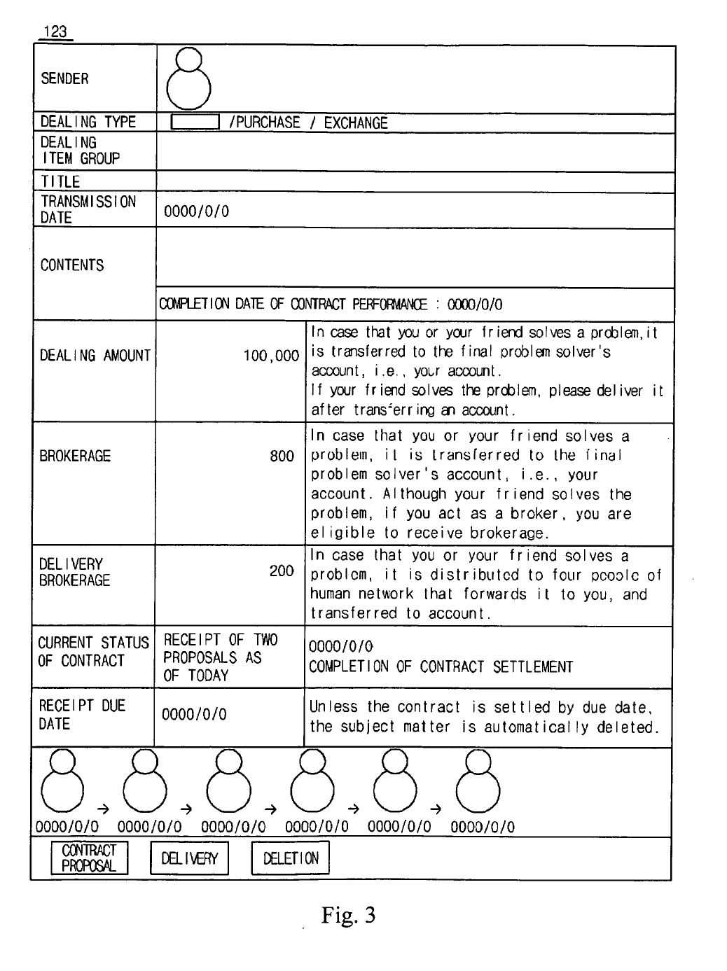

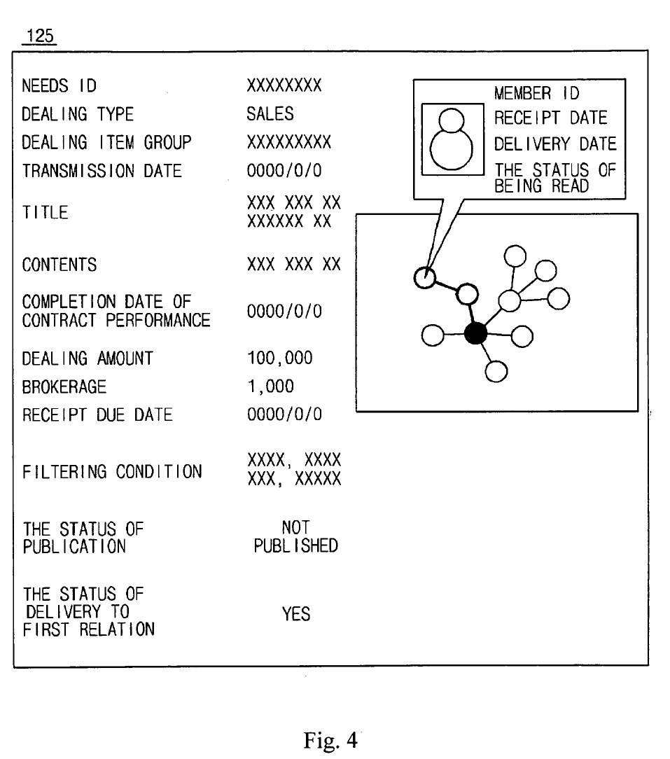

FIG. 1 is an outline diagram of the system schematically representing the constitution of the system for managing social brokering services in an online network according to the present invention; FIG. 2 is a drawing representing an embodiment of Needs requests provided for Social Brokering Users in an application server of the system for managing social brokering services in an online network according to the present invention; FIG. 3 is a drawing representing an embodiment of Needs information provided for Social Forwarders or Social Brokers in the application server of the system for managing social brokering services in an online network according to the present invention; and FIG. 4 is a drawing representing an embodiment of a brokering social network map provided for Social Brokering Users in the application server of the system for managing social brokering services in an online network according to the present invention.

First, specifically explaining on terms and rules used in the present invention, Social Brokering indicates behavior solving problems via human connection, receiving compensation, and forming human connection in such a process in the social human connection of the online social network.

Social Brokering User indicates a member who uses the social brokering system for resolving different kinds of his or her Needs.

Social Broker indicates a member who solves problems by taking various Needs of the Social Brokering User, and is distributed with compensation for solving problems and brokerage.

Social Forwarder indicates a member who simply delivers Needs of User to the final problem solver via human connection, and is distributed with brokerage upon solving problems by Social Broker behind the Social Forwarder in the process of delivering Needs. Social Forwarding indicates that the Needs of Social Brokering User, transmitted from the front step of human connection, is delivered to the first relation of oneself.

Referring to FIGS. 1 to 4, the system (100) for managing social brokering services in an online network according to the present invention is composed of social network database (110); an application server (120); a Needs server (130); a payment server (140); and an Escrow account server (150).

First, the social network database (110) is constituted with member information database (111) storing personal information including ID(s), name(s), email address(es), telephone number(s), working place(s), field of work, address(es), nationality, school(s) of each member; a member ID wherein the member ID whose human connection is based on the social network can be confirmed; human network information database (113) storing member IDs, and the member ID of the first connection; and Needs information (115) storing the Needs information given with Needs IDs for using social brokerage. In this case, as explained above, human network information using the social network is used in an ordinary manner, and its repetitive explanation is omitted hereby. In this case, personal information including a member, a member ID of the first relation, and requested Needs information can be known by member information database (111), human network information database (113), and Needs information (115) with inputting his or her member ID.

Further, the application server (120) controls the system on the whole, providing separate Needs request description window (121) when the written Needs request is requested to be described through MyPage after logging in under condition that Social Brokering User, acting as a member, connects to the homepage of the application server (120) via a wire and wireless Internet network by using a client computer (101). In this case, as illustrated in FIG. 2, Social Brokering User can input or set up types of dealing, dealing item group(s), contends of Needs, dates of contract completion, application due dates, transaction amounts, brokerage, filtering condition, communication network steps, and whether or not to be open.

In the application server (120), if the Needs request is inputted and charges for use is paid, it is converted into Needs information and stored as Needs information database (115) of the social network database (110); if Social Broker, acting as a member, delivers written Needs proposal for the written Needs request by using the client computer (101) and connecting to the homepage of the application server (120) via wire and wireless Internet, the Needs proposal for the written Needs request is provided with Social Brokering User; and transfer for contract is executed upon settling a contract between Social Broker and Social Brokering User. In this case, it is desirable to set up the minimum amounts (e.g., 2,000 won per one case) while charges for use are required to be discriminated by a communication network step (e.g., 2,000 won upon setting up the first step, and 3,000 won upon setting up the second step).

In the application server (120), if Social Brokering User wishes sales and then sales contract between the user and Social Broker is established, payment of purchase amount is requested to the Social Broker; if payment is settled by requesting payment of brokerage to Social Broker User, payment amount is saved to the Escrow account server (150) and a written contract is transmitted to the user and the Social Broker User; if the Needs for the contract is completed to be executed, brokerage is distributed to Social Forwarder and Social Broker in accordance with distributed rates of preset brokerage; and sales amount is paid to the Social Broker User. In this case, it is desirable to set up the minimum amounts (e.g., 10,000 won per one case) while brokerage is required to set the amount up by constant rates of dealing payment (e.g., 1% from dealing amount). Further, in this case, distributed rates of brokerage are required to be differentiated by the communication network step (e.g., distributed by 20% and 80% for Social Forwarder and Social Broker, respectively), or be identically applied. At this stage, it is desirable to make payment of much more amounts of brokerage to Social Broker for the reason that in case Social Broker solves Needs by using off-line personal relationship without directly solving Needs, making payment of the amount of brokerage indicates compensation for Social Broker, and it is helpful for Social Broker to actively solve Needs.

In the application server (120), if Social Broker User wishes purchase or exchange, and purchase or exchange contract between the user and Social Broker is established, payment of purchase amount and brokerage is requested to Social Broker User, or Social Brokering User or Social Broker is requested to make payment as much as balance of exchange value by mutual cooperation; if payment is settled by requesting Social Brokering User to make payment of brokerage, payment amount is saved to the Escrow account server (150) and the written contract is transmitted to Social Brokering User and Social Broker; if Needs for contract is completed to be executed, brokerage is distributed to Social Forwarder and Social Broker in accordance with distributed rates of preset brokerage; and the balance of purchase amount or exchange value is paid to Social Brokering User or Social Broker.

In the application server (120), if a Needs ID is saved to member information database (111) of the member of the first relationship, Needs information, which reaches the member of the first relationship, is displayed on MyPage as a form of a list; Needs information window (123) followed by Needs information is displayed upon clicking on the corresponding Needs information on the list; if the member of the first relationship finishes selecting human connection to deliver Needs information for being delivered to the his or her first relation, the member ID of members who deliver Needs is stored in the Needs information database by linking a Needs delivery item list and numbers of delivery steps, composed by the form of a list, to the Needs ID. In this case, as illustrated on FIG. 3, Needs information, dealing or compensation amount, brokerage, date of contract execution, due date for accepting proposals, a network communication path, the status of contract, etc. are displayed on the Needs information window (123) and therefore, Needs of Social Brokering User can be easily recognized, and a written proposal may be filled out, post connection may be received, or Needs may be deleted if a Needs receiver is willing to solve problems. The network communication path can be shown by connecting abstract profiles of the corresponding human connection to the date of receiving Needs according to Needs acceptance path, and the profile of the corresponding human connection can be seen if the abstract profiles are selected.

In the application server (120), if Social Brokering User requests to look at a map of the brokering social network for checking the process of delivering his or her Needs, as illustrated on FIG. 4, the map of the brokering social network (125) in which the path, to which Needs information is delivered, is imaged as a node and a connection line based on Social Brokering User is displayed by using the Needs delivery item list stored in the Needs information database (115). Here, in the application server (120), if Social Brokering User moves a cursor to the corresponding node of the map of the brokering social network (125), the corresponding member information is displayed, and a screen is moved to the profile or blog of the corresponding member upon clicking on the corresponding node. In addition, in the application server (120), the color of the node of Social Broker delivering the written Needs proposal is differently described and differentiated from those of other nodes, and if there is a contract settled between Social Brokering User and Social Broker, the node of Social Broker, Social Forwarder's node, transmitted to Social Broker, and the color of connection lines are differently described from other nodes and connection lines.

Meanwhile, as for the Needs server (130), undelivered Needs information is delivered to the first relation in accordance with human network information of Social Brokering User or Social Forwarder by searching the Needs delivery list, stored in the Needs information database (115) of the social network database (110).

In Needs server (130), the number of level of a Needs tag is stored with increase by one to enable to check the communication network step and social communication for Needs information is performed in such a process while a Needs tag including member IDs, to which Needs information is transmitted, is stored in member information database (111) by searching the member IDs which is the same as the Needs delivery item in the member information database (111) if the status of Needs turns out to be continued by checking undelivered Needs and monitoring the status of Needs from Needs information database (115). Also, it is desirable to accumulate member IDs of a Needs tag step by step if Needs information is delivered to a member.

In Needs server (130), delivery of Needs information is blocked if it turns out to be duplicatedly delivered after checking preoccupied Needs tag to find out whether the first relation receives the identical Needs information before a Needs tag is stored in the member information database (111) in order to deliver Needs information; and if Social Brokering User sets up filtering conditions, Needs are delivered only to the first relation with identical filtering condition after comparing it with that of member information database (111).

Moreover, as for filtering condition, it is possible to anticipate human connection, available for communication, throughout the filtering condition previously applied in the application server. Therefore, Needs delivery item lists may be obtained from the application server.

If Social Brokering User sets up the status of his or her Needs to stop, it is stored in Needs information database, and delivery of Needs, performed by Needs server, is stopped.

In Needs server (130), publication is set up by Needs request description window (121); if connection communication is established, it is notified on the homepage of the application server (120) simultaneously with being delivered to the first relation of the Social Brokering User; publication is set up by Needs request description window (121); if connection undelivery is set up, it is only notified on the homepage of the application server (120); and if closed status is created through Needs request description window (121), it is only delivered to the first relation of the Social Brokering User.

Further, as for a payment server (140), if payment is executed in the application server (120), payment is processed. Payment server (140) may be used in servers of financial companies, credit card companies, cyber money companies, mobile phone companies, etc.

Meanwhile, as for Escrow account server (150), if payment is executed in the payment server (140) with requested payment from the application server (120), payment amount is deposited; and if there is transfer request from the application server (120), the deposited payment amount is transferred to Social Forwarder, Social Broker, or Social Brokering User.

Meanwhile, the social network server database (110), the application server (120), the Needs server (130), the payment server (140), and the Escrow account server (150) according to the present invention are interconnected through ordinary LANs, or wire and wireless Internet networks.

Hereinafter, referring to FIGS. 1 to 8, the detailed explanation on the method for managing the social brokering services in an online social network according to the present invention is as follow:

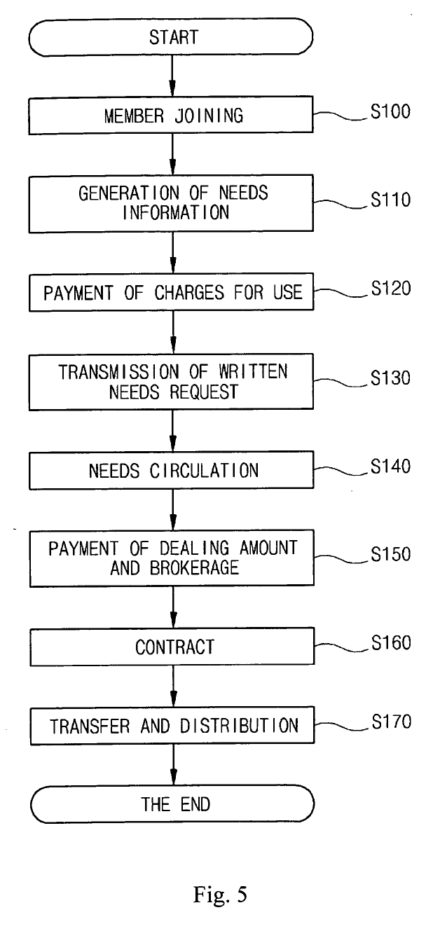

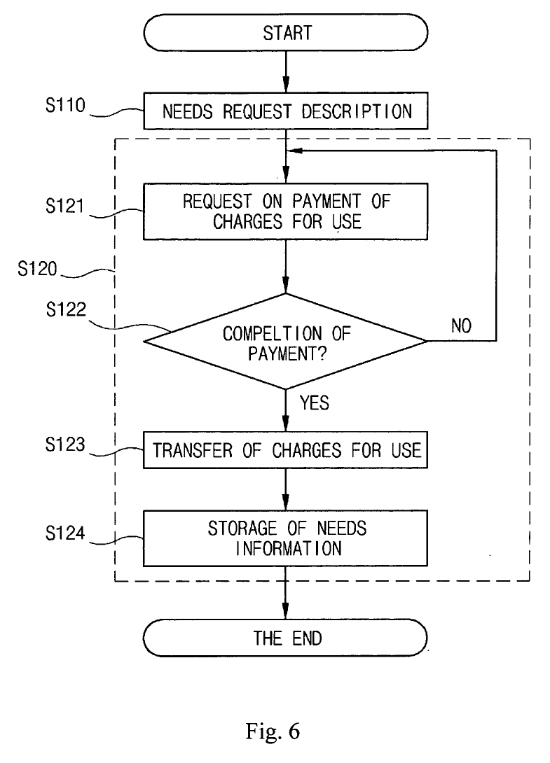

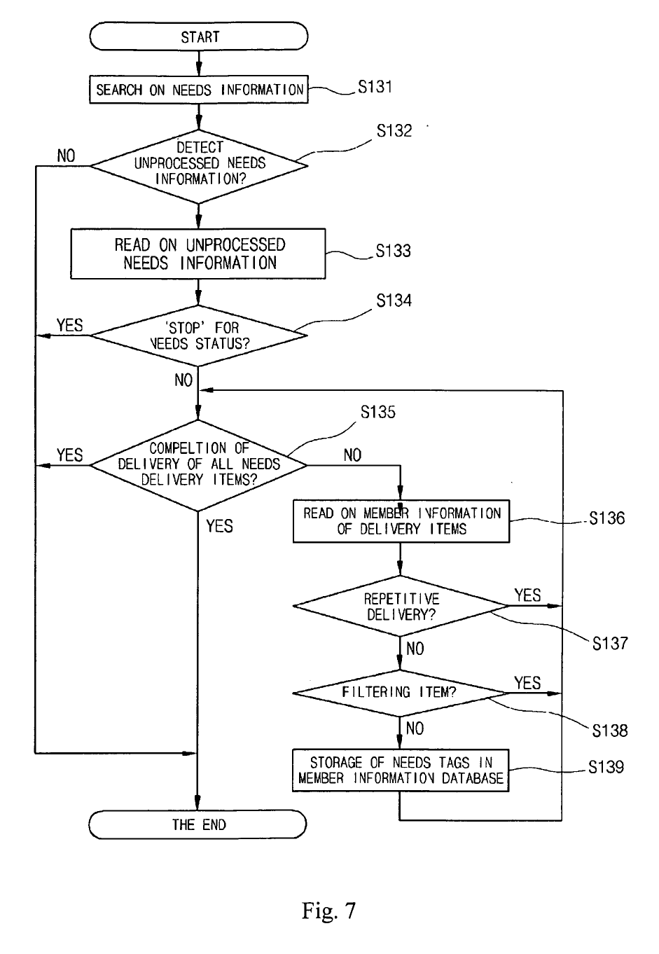

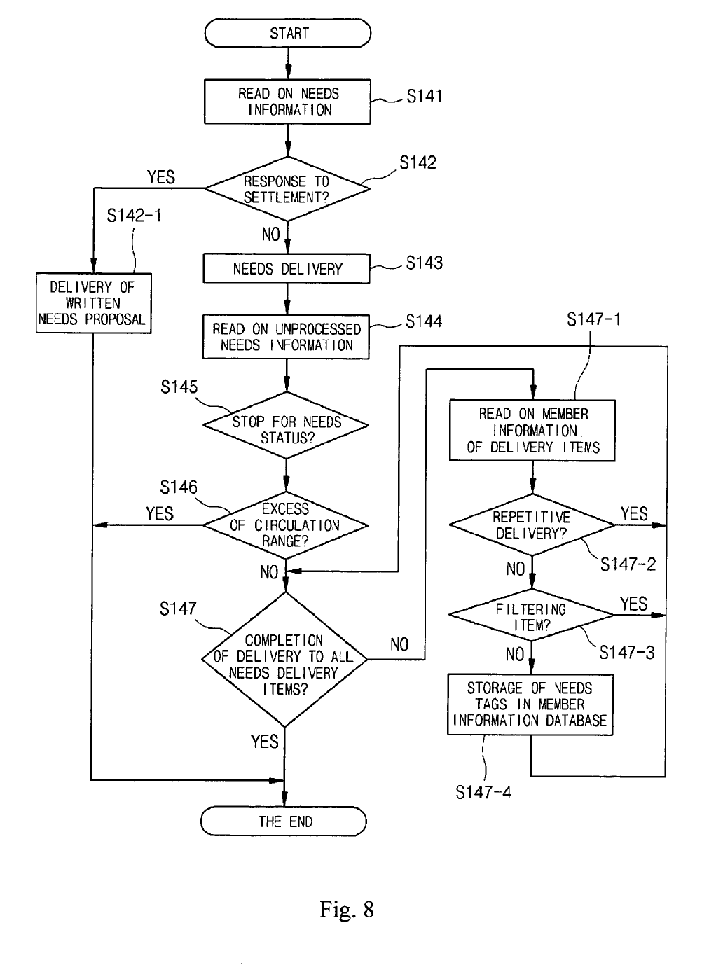

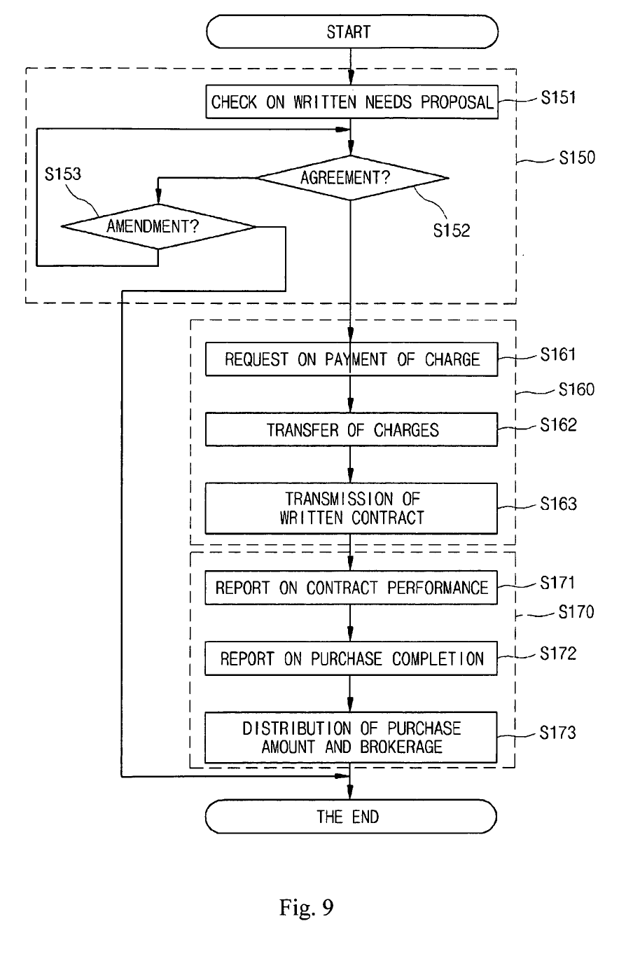

FIG. 5 is an action flow diagram for explaining the method for managing social brokering services in an online network according to the present invention; FIG. 6 is an action flow diagram representing steps of generating and delivering Needs information in the method for managing social brokering services in an online network according to the present invention; FIG. 7 is an action flow diagram representing the step of circulating Needs in the method for managing social brokering services in an online network according to the present invention; FIG. 8 is an action flow diagram representing the step of suggesting Needs in the method for managing social brokering services in an online network according to the present invention; and FIG. 9 is an action flow diagram representing steps of saving, contracting, and distributing bills to be paid in the method for managing social brokering services in an online network according to the present invention.

Referring to FIG. 5, the method for managing social brokering services in an online network according to the present invention is composed of: member joining step of storing human network information to the social network database and creating human connection after recording personal information on the website of the application server and joining as a member (S100); Needs information generating step of filling out desired Needs requests and generating Needs information by a member himself acting as Social Brokering Users after joining the website (S110); payment step of executing payment of charges for use by interconnecting said application sever with the payment server when Needs information is completed to be generated (S120); Needs requests delivering step of storing Needs information, which is Needs requests recorded by the application server, to said social network database and delivering it to the first member of human connection via Needs server when payment of charges for use is completed (S130); Needs circulating step of delivering proposal information on written Needs proposal, recorded by the first member of the human network acting as Social Broker, to the Social Brokering User from said Needs server, or delivering Needs information to the first relation of the first member of the human network by the first member of the human network acting as Social Forwarder (S140); payment saving step of executing payment amount and brokerage, or brokerage according to types of dealing by interconnecting with said payment server in said application server if the proposal information, transmitted by Social Brokers, is accepted by Social Brokering Users, and transferring and saving payment amount to an Escrow account server (150) when payment is executed (S150); contracting step of transmitting a written contract of said application server to Social Brokering Users and Social Brokers when transfer is settled (S160); and distributing and transferring step of distributing brokerage to Social Brokers and Social Forwarders in accordance with distributed rates of brokerage by being used with payment amount, saved in said Escrow account server (150), by the application server (120) when message for completion of contract execution is transmitted from Social Brokers and compensation is requested to be transferred by Social Brokering Users, and transferring payment amount in accordance with types of dealing to Social Brokers or Social Brokering Users (S170).

Specifically explaining the step of generating Needs information (S110, S120) by referring to FIG. 6, the member who enters the homepage provided by the application server (120), i.e., Social Brokering User, fills out written Needs request to purchase an item through his or her connection (S110). In this case, he can select all or some of his first relation and limits communication connection step. In addition, he can set up whether or not to be open, and to be delivered to the first relation upon publication.

If Social Brokering User puts an input in Needs request description window (121), that is, clicks on delivery button by completing to describe the written Needs request, payment of charges for use is performed in the application server (120) after showing charges for use by being interconnected with payment server (140) (S121, S122). Also, in the application server (120), charges for use is transferred to the account of the company which provides the social brokering system (S123).

When payment of charges for use is performed, Needs information, Needs communication items, and the delivery step number, generated by Social Brokering User, are stored to the Needs information database (115) by the application server (120) (S124). In this case, Needs information is contents regarding the written Needs request, and Needs communication item indicates ID lists of members who will deliver Needs. Further, a unique Needs ID is given to Needs information.

Specifically explaining on the written Needs request delivering step (S130) by referring to FIG. 7, unprocessed Needs information is read (S133) by the Needs server (130) in case that it is found to be unprocessed Needs by searching Needs information in the Needs information database (115) of the social network database (110) (S131).

Next, in the Needs server (130), in case that it is confirmed by checking the status of Needs that it is not stopped (S134), and it is shown by checking whether all are completed to be delivered in the Needs communication items that the delivery of Needs is not completed (S135), the information on member ID which is the same as Needs communication item, included in undelivered Needs information, is read (S136).

Furthermore, in the Needs server (130), in case that the filtering condition regarding the item by which Needs is delivered is described while it is not a repetitive transmission by confirming whether that the first relation is transmitted with the identical Needs information (S137), and it is found to be corresponded in comparison with the filtering condition and member information database (111) (S138), a Needs tag is delivered to the first relation according to human network information of Social Brokering User by storing the Needs tag, including each member ID by which Needs information is delivered to member information database (111) by searching member ID which is the identical to Needs communication item in the member information database (111) (S139). In this case, in the Needs server (130), social communication of Needs information is performed after increasing the step number of the Needs tag by one to make it possible to check the communication connection step. Further, as for the filtering condition, it is shown whether or not to deliver Needs communication with the application to column regarding personal information of members, stored in the member information database (111) in a manner of using string search, or comparison of figures. Furthermore, Needs ID is included in the Needs tag and therefore, it can be known whether or not to be repetitively delivered.

Meanwhile, in the Needs server (130), publication is set up by Needs request description window (121); if connection communication is established, it is notified on the homepage of the application server (120) simultaneously with being delivered to the first relation of the Social Brokering User; publication is set up by Needs request description window (121); if connection undelivery is set up, it is only notified on the homepage of the application server (120); and if closed status is created through Needs request description window (121), it is only delivered to the first relation of the Social Brokering User.

Specifically explaining on the Needs circulating step (S140) by referring to FIG. 8, in the application server (120), when a member logs in a client computer (101), member information database (111) is read and the received Needs information is displayed. In this case, whether or not to receive Needs information can be shown on messages or MyPage; it can be displayed in the type of pop-up window; and any method of showing receipt is available.

In addition, in the application server (120), if a member clicks on detailed information on Needs, the identical Needs information is searched from Needs information database (115) by using Needs ID of the Needs tag obtained by the member and then, the Needs information window (123) of the identical Needs information is displayed (S141). In this case, since IDs of all members from users, who first describe Needs, to members, who deliver Needs to themselves, are stored in the Needs tag, Needs information, dealing amounts, brokerage, and connection communication paths are shown by the application server (400) through Needs information window (123) in a manner of reading member information database (111) and Needs information database (115); receipt dates for each human connection and abstract profiles are displayed by the connection communication path in accordance with communication path; and if the corresponding abstract profile is selected, it is possible to open the profile.

Under the above condition, if the member himself delivers the Needs proposal, including intention of settlement, to Social Brokering User to act as Social Broker (S142-1), the Needs proposal is stored in the Needs information database (115).

On the contrary, the member himself delivers Needs information to his first relation to act as Social Forwarder (S143).

Meanwhile, in the Needs server (130), unprocessed Needs information is read from the Needs information database (115) of social network database (110) (S144).

Next, in the Needs server (130), in case that it is confirmed by checking the status of Needs that it is not stopped (S145), it is checked whether or not to limit delivery ranges (level numbers for which Social Brokering User sets up) (S146). Further, in case that it is shown by checking whether all are completed to be delivered in the Needs communication items that the delivery of Needs is not completed (S147), the information of member ID which is the same as Needs communication item, included in undelivered Needs information, is read (S147-1).

Also, in the Needs server (130), in case that the filtering condition regarding the item by which Needs is delivered is described while it is not a repetitive transmission by confirming whether that the first relation is transmitted with the identical Needs information (S147-2), and it is found to be corresponded in comparison with the filtering condition and member information database (111) (S147-3), member IDs and Needs tags by which Needs information is delivered to member information database (111) are stored by searching member IDs which are the identical to Needs communication items in the member information database (111) (S147-4), and social communication of Needs information is performed after increasing the step number of the Needs tag by one in order to enable to check the communication connection step.

Meanwhile, in the application server (120), if Social Brokering User requests to look at a map of the brokering social network on MyPage for checking the process of delivering his or her Needs, the map of the brokering social network (125) in which the path, to which Needs information is delivered, is imaged as a node and a connection line based on Social Brokering User is displayed and confirmed. In this case, communication information in the type that one ID of members of Social Forwarder and several IDs of members, who receive delivery, are gathered is checked by information for forming a brokering social network map in a manner of searching lists of Needs communication items from undelivered Needs information with inputting Needs IDs. Also, the brokering social network map (125) is shown in the image types, in which the connection that Needs is delivered based on a user, and communication paths are described as a node and a connection line among nodes, respectively. In the node of the graph, if a picture, a node member enters, is shown, or a mouse approaches to the node, brief abstract of personal information comes up, or a screen moves to a profile or a blog of the corresponding member with a mouse click, or the node with suggestion for current intention of settlement is differently expressed; and if there is brokering contract, it is possible for users to expand convenience, such as different expression of intermediate nodes and connection lines related to contracts.

Specifically explaining on the payment saving step, the contracting step, and distributing step (S150-S170) by referring to FIG. 9, in the application server (120), if Social Brokering User logs in a client computer (101), the received written Needs proposal is displayed on the screen by reading Needs information database (115) (S151). In this case, since it may be possible to receive several written Needs proposal for one Needs request, written Needs proposal is displayed by the application server (120) in the tree type for one Needs request. Here, it is desirable to show the contents of intention of settlement, and connection of communication processes together in the written Needs proposal.

If Social Brokering User settles a contract (that is, purchase decision) with agreement for specific proposal (S152), it is requested to make payment of brokerage and dealing amount toward Social Brokering User and Social Broker by the application server (120), respectively (S161), and if payment is settled, payment amount which indicates brokerage and dealing amount is transferred and stored to the Escrow account server (S162). In this case, Social Brokering User or Social Broker can suggest amendment on contents of proposal of others without agreement for the contents of proposal. If the contents of proposal is amended, the amended contents of proposal is delivered to others; the above processes are repetitively performed until making an agreement; and if the agreement is not achieved until due date of receiving proposal, all routines are closed (S153).

If payment is completed to be settled, the contents of contract is stored in the Needs information database (115) by the application server (120); and related written Needs contract from the Needs information database (115) is displayed on the screen of Social Broker, who sends intention of settlement, by the application server (120) (S163). In this case, to make several contracts for one Needs, one Needs information is connected by one to N relation with written contract. In addition, in the application server (120), Social Forwarder can check whether or not to make a contract, and brokerage by informing Social Forwarder, who participates in delivering Needs, of contract information including dealing amount, brokerage, connection communication path, etc.

Meanwhile, Social Broker finishes solving contracted Needs (e.g., purchase item delivery), and reports completion of contract performance which notifies completion of contract performance on MyPage of the application server (S171). Then, it is informed of Social Brokering User by the application server, Social Brokering User checks it and reports purchase completion on MyPage of the application server (S172).

Next, in the application server (120), the payment amount, saved in said Escrow account server (150), is distributed as brokerage in accordance with distributed rates of brokerage to Social Broker and Social Forwarder by using the payment server (140), and dealing amount is transferred to Social Broker (S173).

Further, if Social Brokering User reports purchase completion (Needs completion and compensation transfer) (S172), the status of Needs of Needs information database (115) and the contract status are changed to completion by the application server (120), and the completed Needs ID is reported to the payment server (140). Meanwhile, in the payment server (140), Needs ID, in which that status of Needs and the contract status in the Needs information database (115) are completed, is searched by periodic examination without notifying Needs ID and is automatically processed.

Meanwhile, although it is explained in the above that the dealing type indicates purchase, as for sales, Social Brokering User makes a payment of charges for use; and upon completing a contract in the future, Social Broker makes a payment of dealing amount, and Social Brokering User makes a payment brokerage.

Further, in the above, as for the dealing type as exchange, Social Brokering User makes a payment of charges for use, and upon completing a contract in the future and causing balance of exchange value in accordance with exchange, Social Brokering User or Social Broker make a payment of balance of exchange value in accordance with contracts, and Social Brokering User makes a payment of brokerage.

Meanwhile, in the application server (120), when transfer and distribution are completed, Social Brokering User or Social Broker are provided with a separate reputation system (not illustrated) which can describe reputation, which is the same as credit rating of Social Brokering User or Social Broker, and credit rating of Social Brokering User or Social Broker can be checked by changing reputation, achieved through a reputation system, into figures.

The present invention can be variously modified and embodied by several types of forms, and particular illustrative embodiments are merely described in the detailed description of the invention. However, it should be appreciated in such a manner that the present invention is not limited as a particular type, mentioned in the detailed description, but rather it comprises all modified materials, equal materials, and substitutes within the spirit and the range of the present invention, defined by the enclosed claims herewith.

The method and system for managing social brokering services in an online social network according to the present invention can be used in on-line and off-line dealing fields along with electronic commerce, and various kinds of social services.

What is claimed is:

1. A system for managing social brokering services in an online social network, the system comprising: social network database storing member information, human network information by member information on basis of social network, and Needs information; an application server converting written Needs request into Needs information and storing it as said social network database after making payment of charges for use when the written Needs request is inputted from Social Brokering Users, acting as members, providing Needs proposal with Social Brokering Users when the written Needs proposal is conveyed from Social Brokers, members, making payment of the amount according to dealing types and contracts upon establishing contracts between Social Brokering Users and Social Brokers, and transferring the payment amount upon completing the contract; a Needs server delivering undelivered Needs information to the first human connection according to information on human connection of Social Brokering Users or Social Forwarders by searching Needs information stored in said social network database; and a payment server processing charges for use and payment when payment is executed in said application server.

2. The system for managing social brokering services in an online social network according to claim 1, further comprising an Escrow account server, wherein if payment is executed in a payment server with requested payment from the application server, payment amount is deposited; and if there is transfer request from the application server, the deposited payment amount is transferred to Social Forwarder, Social Broker, or Social Brokering User.

3. The system for managing social brokering services in an online social network according to claim 1, wherein the social network database comprises member information database storing personal information including ID(s), name(s), email address(es), telephone number(s), working place(s), field of work, address(es), nationality, school(s) of each member; member ID wherein member ID whose human connection is based on the social network can be confirmed; human network information database storing member ID, and member ID of the first connection; and Needs information storing the Needs information given with Needs ID for using social brokerage.

4. The system for managing social brokering services in an online social network according to claim 1, wherein the application server is characterized in that if Social Brokering User requests to describe the written Needs request, a separate Needs request description window is provided on MyPage.

5. The system for managing social brokering services in an online social network according to claim 4, wherein the Needs request description window is characterized in that Social Brokering User can input or set up types of dealing, dealing item groups, contends of Needs, dates of contract completion, application due dates, transaction amounts, brokerage, filtering condition, communication network steps, and whether or not to be open.

6. The system for managing social brokering services in an online social network according to claim 5, wherein upon selection between whether or not to be published, Social Brokering User in the application server selects publication and checks whether or not to deliver human network.

7. The system for managing social brokering services in an online social network according to claim 5, wherein the dealing type is one of selling, purchase, and exchange.

8. The system for managing social brokering services in an online social network according to claim 1, wherein while charges for use are required to be discriminated by a communication network step, minimum amounts are set up.

9. The system for managing social brokering services in an online social network according to claim 2, wherein the application server is characterized in that if sales contract between the Social Brokering User and Social Broker is established, payment of dealing (purchase) amount is requested to the Social Broker; if payment is settled by requesting payment of brokerage to Social Broker User, payment amount is saved to the Escrow account server (150) and a written contract is transmitted to the user and the Social Broker User; if the Needs for the contract is completed to be executed, brokerage is distributed to Social Forwarder and Social Broker in accordance with distributed rates of preset brokerage; and sales amount is paid to the Social Broker User.

10. The system for managing social brokering services in an online social network according to claim 9, wherein the application server is characterized in that if purchase or exchange contract between the Social Brokering User and Social Broker is established, payment of purchase amount and brokerage is requested to Social Broker User, or Social Brokering User or Social Broker is requested to make payment as much as balance of exchange value by mutual cooperation; if payment is settled by requesting Social Brokering User to make payment of brokerage, payment amount is saved to the Escrow account server (150) and the written contract is transmitted to Social Brokering User and Social Broker; if Needs for contract is completed to be executed, brokerage is distributed to Social Forwarder and Social Broker in accordance with distributed rates of preset brokerage; and the balance of purchase amount or exchange value is paid to Social Brokering User or Social Broker.

11. The system for managing social brokering services in an online social network according to claim 10, wherein the brokerage is required to set the amount up by constant rates of dealing payment while the minimum amounts are set up.

12. The system for managing social brokering services in an online social network according to claim 10, wherein the distributed rates of brokerage are required to be differentiated by a communication network step, or be identically applied.

13. The system for managing social brokering services in an online social network according to claim 1, wherein the application server is characterized in that if Needs ID is saved to member information database of the member of the first relation, Needs information, which reaches the member of the first relation, is displayed on MyPage as a form of a list; Needs information window followed by Needs information is displayed upon clicking on the corresponding Needs information on the list; if the member of the first relation finishes selecting human network to deliver Needs information for being delivered to the his or her first relation, member ID of members who deliver Needs is stored in the Needs information database by linking a Needs delivery item list and numbers of delivery steps, composed by the form of a list, to Needs ID.

14. The system for managing social brokering services in an online social network according to claim 1, wherein Needs information, dealing or compensation amount, brokerage, date of contract execution, due date for accepting proposals, network communication paths, the status of contract, etc. are displayed on the Needs information window; and a written proposal may be filled out, post connection may be received, or Needs may be deleted if a Needs receiver is willing to solve problems.

15. The system for managing social brokering services in an online social network according to claim 14, wherein the Network communication path is characterized in that abstract profiles of human connection are displayed with dates of receiving each Needs; and upon clicking it, the profile of the corresponding human network is displayed.

16. The system for managing social brokering services in an online social network according to claim 1, wherein the application server is characterized in that if Social Brokering User requests to look at a map of the brokering social network for checking the process of delivering his or her Needs, the map of the brokering social network in which the path, to which Needs information is delivered, is imaged as a node and a connection line based on Social Brokering User is displayed by using the Needs delivery item list stored in the Needs information database.

17. The system for managing social brokering services in an online social network according to claim 16, wherein the application server is characterized in that if Social Brokering User moves a cursor to the corresponding node of the map of the brokering social network, the corresponding member information is displayed, and a screen is moved to the profile or blog of the corresponding member upon clicking on the corresponding node.

18. The system for managing social brokering services in an online social network according to claim 16, wherein the application server is characterized in that the color of the node of Social Broker, to which the written Needs proposal is delivered, is differently described and differentiated from those of other nodes, and if there is a contract settled between Social Brokering User and Social Broker, the node of Social Broker, Social Forwarder's node, transmitted to Social Broker, and the color of connection lines are differently described from other nodes and connection lines.

19. The system for managing social brokering services in an online social network according to claim 5, wherein the Needs server is characterized in that undelivered Needs is searched from the Needs information database; and Needs information is delivered after increasing the number of level of a Needs tag by one to enable to check the communication network step while member IDs and a Needs tag, to which Needs information is transmitted, are stored in member information database by searching member IDs which is the same as the Needs delivery item in the member information database.

20. The system for managing social brokering services in an online social network according to claim 5, wherein the Needs server is characterized in that delivery of Needs information is blocked if it turns out to be duplicatedly delivered after checking whether the first relation receives the identical Needs information before the Needs tag is stored in the member information database in order to deliver Needs information; and if Social Brokering User sets up filtering conditions, Needs is delivered only to the first relation with identical filtering condition after comparing it with that of member information database.

21. The system for managing social brokering services in an online social network according to claim 6, wherein the Needs server is characterized in that publication is set up by a Needs request description window; if connection communication is established, it is notified on the homepage of the application server simultaneously with being delivered to the first relation of the Social Brokering User; publication is set up by the Needs request description window; if connection undelivery is set up, it is only notified on the homepage of the application server; and if closed status is created through the Needs request description window, it is only delivered to the first relation of the Social Brokering User.

22. A method for managing social brokering services in an online social network, the method comprising steps of: member joining step of storing information on human connection to the social network database and creating human connection after recording personal information on the website of the application server and joining as a member; Needs information generating step of filling out desired Needs requests and generating Needs information by a member himself acting as Social Brokering Users after joining the website; payment step of executing payment of charges for use by interconnecting said application sever with the payment server when Needs information is completed to be generated; Needs requests delivery step of storing Needs information, which is written Needs request recorded by the application server, to said social network database and delivering it to the first member of human connection via a Needs server when payment of charges for use is completed; Needs circulating step of delivering proposal information on written Needs proposal, recorded by the first member of the human network acting as Social Broker, to the Social Brokering User from said Needs server, or delivering Needs information to the first relation of the first member of the human network by the first member of the first network acting as Social Forwarder; payment saving step of executing payment amount and brokerage, or brokerage according to types of dealing by interconnecting with said payment server in said application server if the proposal information, transmitted by Social Brokers, is accepted by Social Brokering Users, and transferring and saving payment amount to an Escrow account server when payment is executed; contracting step of transmitting a written contract of said application server to Social Brokering Users and Social Brokers when transfer is settled; and distributing and transferring step of distributing brokerage to Social Brokers and Social Forwarders in accordance with distributed rates of brokerage by using payment amount, saved in said Escrow account server, when message for completion of contract execution is transmitted from Social Brokers and compensation is requested to be transferred by Social Brokering Users, and transferring payment amount in accordance with types of dealing to Social Brokers or Social Brokering Users.

23. The method for managing social brokering services in an online social network according to claim 22, wherein the dealing type is one of selling, purchase, and exchange.

24. The method for managing social brokering services in an online social network according to claim 22, wherein Needs information generating step is characterized in that if Social Brokering User requests to describe the written Needs request, a separate Needs request description window is provided on MyPage of the application server as the type of GUI (Graphic User Interface).

25. The method for managing social brokering services in an online social network according to claim 24, wherein the Needs request description window is characterized in that Social Brokering User can input or set up types of dealing, dealing item groups, contends of Needs, dates of contract completion, application due dates, transaction amounts, brokerage, filtering condition, communication network steps, and whether or not to be open.

26. The method for managing social brokering services in an online social network according to claim 22, wherein while charges for use are required to be discriminated by the communication network step, the minimum amounts are set up.

27. The method for managing social brokering services in an online social network according to claim 22, wherein the brokerage is required to set the amount up by constant rates of dealing payment while the minimum amounts are set up.

28. The method for managing social brokering services in an online social network according to claim 22, wherein the distributed rates of brokerage are required to be differentiated by the communication network step, or be identically applied.

29. The method for managing social brokering services in an online social network according to claim 22, wherein the Needs circulating step is characterized in that if Social Brokering User requests to look at a map of the brokering social network for checking the process of delivering his or her Needs, the map of the brokering social network in which the path, to which Needs information is delivered, is imaged as a node and a connection line based on Social Brokering User is displayed.

30. The method for managing social brokering services in an online social network according to claim 29, wherein the Needs circulation step is characterized in that if Social Brokering User moves a cursor to the corresponding node of the map of the brokering social network, the corresponding member information is displayed, and a screen is moved to the profile or blog of the corresponding member upon clicking on the corresponding node.

31. The method for managing social brokering services in an online social network according to claim 30, wherein the Needs circulating step is characterized in that the color of the node of Social Broker, to which the written Needs proposal is delivered, is differently described and differentiated from those of other nodes, and if there is a contract settled between Social Brokering User and Social Broker, the node of Social Broker, Social Forwarder's node, transmitted to Social Broker, and the color of connection lines are differently described from other nodes and connection lines.

32. The method for managing social brokering services in an online social network according to claim 29, wherein the Needs circulating step is characterized in that undelivered Needs is searched from the Needs information database; and Needs information is delivered after increasing the number of level of a Needs tag by one to enable to check the communication network step while member IDs and Needs tags, to which Needs information is transmitted, is stored in member information database by searching member IDs which is the same as the Needs delivery item in the member information database.

33. The method for managing social brokering services in an online social network according to claim 29, wherein the Needs circulating step is characterized in that delivery of Needs information is blocked if it turns out to be duplicatedly delivered after checking whether the first relation receives the identical Needs information before the Needs tag is stored in the member information database in order to deliver Needs information; and if Social Brokering User sets up filtering conditions, Needs is delivered only to the first relation with identical filtering condition after comparing it with that of member information database.

34. The method for managing social brokering services in an online social network according to claim 22, wherein the delivery in the Needs circulating step can be stopped in the delivery process in accordance with Social Brokering User's selection.

35. The method for managing social brokering services in an online social network according to claim 22, wherein the payment saving step is characterized in that as for the Needs for purchase among dealing types, Social Brokering User is requested to make a payment of dealing amount and brokerage.

36. The method for managing social brokering services in an online social network according to claim 22, wherein the payment saving step is characterized in that as for the Needs for sales among dealing types, Social Broker is requested to make a payment of purchase amount, and Social Brokering User is requested to make a payment of brokerage.

37. The method for managing social brokering services in an online social network according to claim 22, wherein the payment saving step is characterized in that as for the Needs for exchange among dealing types, Social Brokering User is requested to make a payment of brokerage, and Social Brokering User or Social Broker is requested to make a payment of balance of exchange value by contract after making mutual agreement.

38. The method for managing social brokering services in an online social network according to claim 22, wherein the payment saving step is characterized in that Social Brokering User or Social Broker can amend the dealing amount which is set in Needs information.

39. The method for managing social brokering services in an online social network according to claim 38, wherein the contracting step is characterized in that contract information is transmitted to Social Forwarder who participates in delivering Needs.

40. The method for managing social brokering services in an online social network according to claim 22, wherein the distributing and transferring step is characterized in that when transfer and distribution are completed, Social Brokering User or Social Broker are provided with a separate reputation system which can check reputation such as credit rating of Social Brokering User or Social Broker.
